(19) United States
(12) Patent Application Publication
(10) Pub. No.: US 2006/0029909 A1
(43) Pub. Date: Feb. 9, 2006

(54) Method and apparatus for producing objective color references for color matching or identifying

(76) Inventor: Michael D. Kaczkowski, Brandon, MS (US)

Correspondence Address: Mr. Timothy D. Smith, 5075 Canton Heights Dr., Jackson, MS, 39211, US

(21) Appl. No.: 11/196,676

(22) Filed: Aug. 3, 2005

Related U.S. Application Data
(60) Provisional application No. 60/599,296, filed on Aug. 5, 2004.

(51) Int. Cl. G09B 19/00

(52) U.S. Cl. 434/98

(57) ABSTRACT

This is a method and apparatus through which individuals can objectively create or match colors. It is a device in which transparent discs containing varying color pigmentation are placed within an opaque holder and manipulated in such a way as to combine the colors in a viewing window on said holder allowing the viewer to visibly see the color displayed and manipulate that color with corresponding color tabs on said discs to obtain a desired result. The varying colors on the transparent discs are labeled with symbolic indicators so that the viewer can reference the color being viewed in the viewing window when either viewing a single disc or multiple discs together. The invention can be used either by itself without the use of an objective object or can be used with reference to an objective object. The invention has many applications such, but not limited to, matching skin tone to prosthetic devices and creating or matching paint colors for domestic or commercial application.

### CROSS REFERENCES TO RELATED APPLICATIONS

### U.S. Patent Documents

| | | | |
|---|---|---|---|
| 6,740,154 | May, 2004 | Pace, et al. | 106/456 |
| 6,632,093 | Oct., 2003 | Rice, et al. | 434/98 |
| 6,111,973 | Aug. 2000 | Holt et al. | 382/100 |
| 4,973,253 | Nov., 1990 | Shook, et al. | 434/104 |
| 4,966,461 | Oct., 1990 | Hooper | 356/406 |
| 4,801,267 | Jan., 1989 | Von Loesch, et al. | 434/101 |

### Parent Case Text

This application claims the benefit of U.S. Provisional Application No. 60/599,296, filed Aug. 5, 2004.

### STATEMENT REGARDING FEDERALLY SPONSORED RESEARCH AND DEVELOPMENT

Not Applicable

### REFERENCE TO A “SEQUENTIAL LISTING,” A TABLE, OR COMPUTER PROGRAM LISTING APPENDIX SUBMITTED ON A COMPACT DISC

Not Applicable

### BACKGROUND OF THE INVENTION

(1) Technical Field of Invention

This invention relates in general to color matching, and in particular to a method and apparatus for creating objective color references. This invention has broad application possibilities and serves as a way by which individuals can create desired colors without reference to any preexisting color for various applications including, including but not limited to, the commercial and residential painting industry. This invention is also very useful when there is a color reference such as in the prosthetic industry in matching skin tone to prosthetic color. However, this invention is by no means limited to just these industries or applications.

(2) Description of Prior Art

As is well known, there are infinite numbers of colors, color schemes and applications of these colors and color schemes. “Color Swatches” are found in hardware stores across the globe that display the various colors available to consumers when certain colors are mixed according to the code with which that desired color is associated.

One of the most important concerns of individuals who seek prosthetic correction is that the prosthetic match the skin tone of the person. Unfortunately, to date there are few, if any, means or apparatus through which this task can be accomplished without delay, over-complicated process or excessive expense. Prosthetic patients may have to travel great distances to see desired prosthesis in order to obtain prosthetic devices that do not truly replicate their skin tone. Photographs may be used in futile attempts to replicate skin tone in the color matching process. Home owners may have to wade through hundreds of “color swatches” that ultimately function only to cause clutter and are easily misplaced. With respect to both of the aforementioned applications, this invention alleviates these and many other problems. A substantial market already exists in the aforementioned areas and there are numerous other markets in which exact colors are desired to fulfill needs.

There are a couple of notable patents that illustrate a means of matching colors in a similar fashion to the present invention. However, these inventions do not accomplish these tasks in the same manner or with the same ease and efficiency of the present invention. Likewise, these patents are not suitable or useful in fields like the commercial painting industry and especially not the prosthetics industry. They unveil no method through which a user may thoroughly and truly utilize and attain results in a like fashion to the present invention. One prior invention utilized color wheels and tabs to manipulate the wheels into place. At first glance this patent may seem similar to the present invention, but upon further inspection there are several key differences that separate them and make the present invention an improvement in the art. The patent being referenced is U.S. Pat. No. 4,801,267. This invention utilized a plurality of color wheels that are embodied by a backing foil and color foil. Paper wheels are disposed between the color wheels. These wheels are manipulated by tabs which reference percentages of color of the opposite side of the device from the recess in which color is scene by the viewer, making it difficult for the viewer to actually reference the color being viewed with the percentage of color being viewed at the same time. The U.S. Pat. No. 4,801,267 is limited to four primary colors which is very much a disadvantage in obtaining or creating color references of a broad range of colors with great specificity. Among other things, the present invention that is the subject of this description utilizes transparent plastic discs that have the percentage of color actually printed on the discs in such a manner as to allow the viewer to see the percentage of color of each individual color in the viewing window at the same time they are viewing the color being made or matched in the window. This is accomplished by the use of symbolic indicators printed on the transparent discs. The present invention is not limited in color and as a result is of a more practical use in a broad array of applications that must have the ability to match or make colors that have shades that only vary a small amount, such as the painting and prosthetics industries. The present invention differs in other aspects as well, all of which are an improvement in the art as is evidenced herein.

### BRIEF SUMMARY OF THE INVENTION

The present invention is a method and apparatus for creating objective color references for colors through the use of a color producing device.

This invention aims to facilitate a more efficient and effective means through which desired colors can be obtained to either match existing colors, such as skin tone, or illustrate colors to be used in other applications, such as wall paint color.

This color matching or identifying device is comprised of one or more transparent circular discs, each containing a different color coating of varying translucency around the disc with color intensity increasing around the disc. These translucent circular discs, which are composed of plastic, are concentrically arranged on top of each other and fastened within an opaque holder by a center pin or rivet. The opaque holder has a front and a back with the translucent discs placed in between these two portions. This center pin or rivet allows the discs to rotate independently of one another either clockwise or counter-clockwise. The opaque holder serves as a means of support for the translucent discs, among other things. The circumference of the discs and holder is the same, therefore the discs are contained within the holder. The opaque holder also contains a window or viewing area through which the transparent discs can be seen. These windows are open viewing areas that are aligned on both the front and back portions of the holder and are cut inward recessing from the periphery of the opaque holder. The back open area can be closed if used without a sample by simply rotating the back portion in such a manner as to remove the opening from behind the viewing area of the translucent discs. When the back viewing or open area of the holder is closed it is preferable that it display a white or neutral background.

Each transparent colored disc will have various color codes, represented by various numerical and alphabetical symbols (“symbolic indicators”), printed on them representing and illustrating the color being seen by the viewer through the viewing area as said viewer rotates the discs within the opaque holder. These symbols will represent the color of the portions of the discs being viewed at the time as well as the percentage of that color being viewed, i.e. R20, BL00, G05 is equivalent to Red 20%, Blue 0% and Green 5%. Each colored disc will have a tab that is manipulated outside of the periphery of the holder and that is labeled according to the color it evidences, i.e. a red disc will have a tab with RED printed on it. The disc will have the color code placed on the transparent aspect of the disc in such a position within the radius of said disc that it will not interfere with the any other color code being seen through the open window at the same time. In other words, each color will have its color code printed the same distance away from the center of the discs all the way around the circumference of the disc. This allows many different colors to be matched together and all of the representative codes will be seen through the viewing area without interfering with one another.

When a user holds the invention and the tabs are placed in their resting or neutral positions on the holder, the viewing area or window exhibits a clear opening and all symbolic indicators show “00”, which represents no presence of color, i.e. R00, BL00, G00. As a user moves a disc using a tab, the viewing area will reflect this change by revealing varying concentrations of color or color changes pursuant to that particular color disc within the open window or viewer area. Also, as the disc is moved by manipulating the corresponding tab, the symbolic indicators linked to the color concentrations will also reflect the change, thereby allowing the user to identify and reference the color sections seen in the viewing window.

The invention becomes an objective color reference when it is put to use either by itself or beside an existing color reference such as a sample specimen, image, paint or color chip, photograph or anything bearing color or pigment. (hereinafter the “Object”). For instance, if the user wants to match his or her skin tone to a prosthetic device they will place the invention beside or adjacent to the amputated or deficient area in which the prosthetic device will be coupled and manipulate the color tabs until a match is obtained between the device and the user's skin tone.

After the user moves the desired discs into the position where the desired color results are achieved in the viewing window, the user/viewer records the corresponding symbolic indicators as seen in the viewing area These indicators together form a code by which this color can be created in the desired medium, be it silicone in a prosthetic application or wall paint in a domestic application. The medium does not have to be silicone or paint, it could be anything that is able to be manufactured and could contain pigments The indicator code numbers are given to the company, agency, individual, or association for a color match to be created. (hereinafter the “Matcher”).

If the Matcher also possesses the same Object as the user, then the Matcher can match, create or alter their colors using the numerical data collected from the invention. If the Matcher does not have the same Object as the user of the invention, the user may send the object or an exact copy of the object to use in conjunction with the data collected by the user as a way of double checking. Therefore the user may send a copy of the medium placed under or adjacent to the viewing window when colors are matched. Obviously, this medium is the reference by which the color will be matched. If the matcher has the invention available and at his or her disposal, all they have to do is collect the corresponding symbolic indicators and manufacture the desired color accordingly.

The invention can be used independently as well. If the user simply wants a shade of custom paint mixed, the back portion of the opaque holder can either be manufactured without a rear viewing window that recesses from the periphery of the holder, or preferably, the back portion of the opaque holder can be rotated independently of the discs and front holder portion to reveal a neutral background when the rear window is rotated out of alignment with the front viewing window. This would provide a built-in neutral backdrop to view the translucent color sections. This application of the invention obviously would be of interest to retailers of paint in that customers could customize their paint color preferences without the need for robust display stands full of swatches of colors. Retailers could replace these display stands with several of the discs and serve the same purpose while consuming far less space. When used in this context, any imaginable color, including but not limited to the primary colors can be used.

If a home owner has an existing paint color on their walls and desires to change the shade of this color yet maintain the integrity of the existing color, this invention can be of us. They can obtain this invention from a vender who uses this method and, with the rear viewing area or window open, so that the front and rear viewing windows of the holder are aligned and are clear when the tabs and discs are in their respective neutral positions, place the invention on the wall or painted area and manipulate the color tabs until the desired color is obtained. The symbolic indicators, coupled with the existing paint color by the retailer will give the consumer their desired color. There are numerous applications in which this method could be applied including virtually anything that bears paint.

This invention is useful because it allows manufacturers or other entities the ability to meet their client's or customer's color matching needs in an objective manner and is not limited to one area or field.

Traditionally when a color sample is sent to a client for approval and the client wants to make a color change, they are forced to use subject terms to communicate the change (i.e. more red, a touch of green, etc.). When skin colors are being matched, users are typically confined to photographs and preordained skin color models. These methods have proven to be less efficient and leave the question of exact color matches unanswered as a photograph is relied upon to find the closet match to these preordained available colors.

This present invention is not limited to painting functions and is not limited by being required to operate off of a target or sample. It can operate independently and may be applied in many different fields of use.

As mentioned before, virtually every paint store or retailer in the country has a booth or display that holds thousands of “color swatches” for consumers to peruse in search of that perfect color. This in ineffective for several reasons. This method of displaying colors takes up valuable space on showroom floors. It can become quite cluttered and messy and is unduly cumbersome to view from the customers perspective. The present invention can serve to solve this problem as well. Entire sections of these displays could essentially be condensed into a few of these “Chromochangers.” Consumers could manipulate the invention in such a way as to come up with a desired color. The symbolic indicators could be recorded by the store attendant and used in the composition of the desired color. The invention aims to save valuable space and allows the consumer to have more control over the colors selected.

### BRIEF DESCRIPTION OF SEVERAL VIEWS OF THE DRAWINGS

FIG. 1. illustrates the invention, called a Photo-Changer Skin Matching System, and its many facets, including the color tabs along the periphery of the holder and the viewing area which is displaying various color codes.

FIG. 2. illustrates a yellow translucent circular disc as well as the numerical/alphabetical codes printed on it in such a fashion that it can be read when seen in the viewing area.

FIG. 3. illustrates the invention as it appears when viewed from the side with the front and back pieces of the holder being held together by a center pin or rivet. In between the front and back holder pieces are the translucent discs.

FIG. 4. Illustrates the invention as seen from behind with the color tabs in their respective neutral positions and the rear viewing window open in such a manner as the discs can be seen when viewed form behind.

FIG. 5. Illustrates a flow chart that demonstrates how the individual or practitioner utilizes this invention in virtually any application.

### DETAILED DESCRIPTION OF THE INVENTION

The present invention pertains to a device through which colors can be illustrated, matched and recorded in a manner in which the color can be duplicated from the data received therefrom. All drawings are schematic, not necessarily to scale and illustrate only parts essential to the understanding of the invention, whereas other parts are omitted from the drawings to preserve clarity. Throughout all drawings identical or similar parts are designated by the same references.

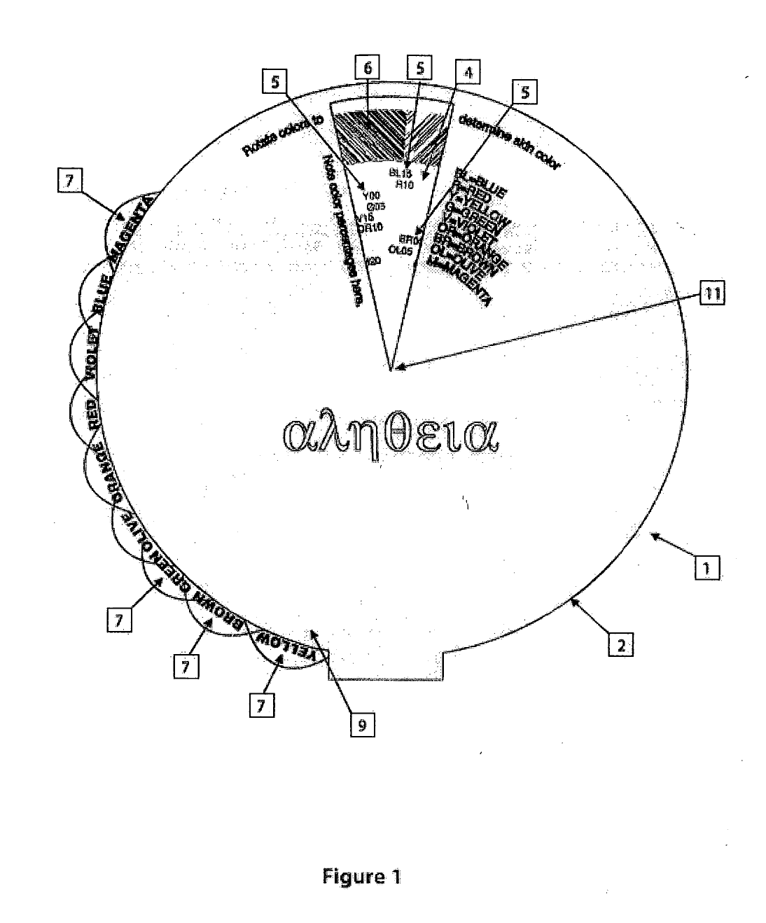

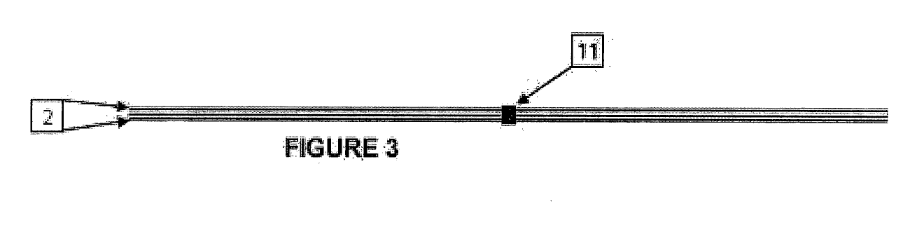

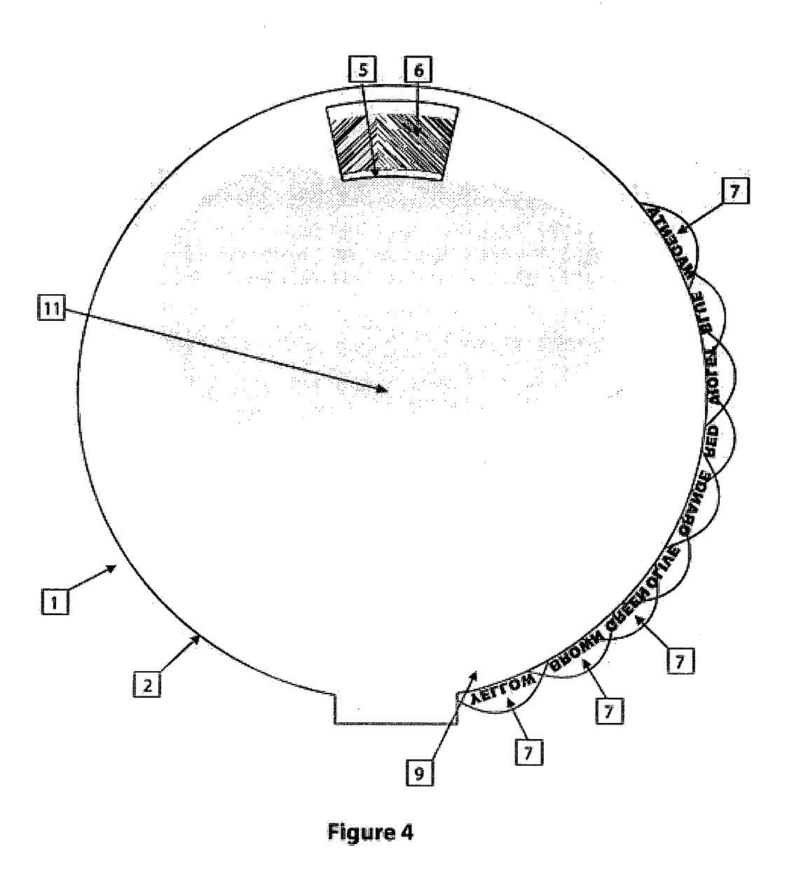

Referring to FIG. 1 through FIG. 4, the invention in placed on a neutral background (1) and the color tabs (7) are moved from their resting positions to evidence their colors as written on the tabs (9). The opaque holder (hereinafter, “Holder”) (2) has a front and back piece or portion that is pinned or riveted together at its center with the transparent discs (3) contained in between. The open window or viewing area (4) is located in the top center portion of the invention and recesses down from the periphery of the holders (2) both front and back and allows viewing of color sections (6) as well as their corresponding symbolic indicators (5) as printed on the corresponding disc (3). The symbolic indicators (5) are an indicator of the percentage of color of the disc (3) at the particular point upon which the indicator (5) is printed and may be represented by either numbers or alphabetic letters, or both. The symbolic indicators (5) are printed on the discs (3) the same distance away from the center of the particular disc (3) around the circumference of the disc (3). Each particular disc (3) will have its symbolic indicators (5) printed in a different position around the circumference of the disc (3) so as to not interfere with the symbolic indicators (5) of other discs when viewed in the viewing area (4) by the user. This prevents overlapping of the symbolic indicators (5) when in the field of view within the viewing window or viewing area (4). The open window or viewing area (4) is open on both sides of the opaque holder (2), but may be closed in the back if the invention is used without a sample by simply rotating the back portion of the holder (2) either clockwise or counterclockwise such that the rear viewing area (4) is not aligned with the viewing area or window (4) on the front portion of the holder (2). The facilitates a neutral background upon which to view colors. The color tabs (7) used to manipulate the discs (3) also identify the color of the disc (3) being manipulated as the name of the particular color is printed on the color tab (7).

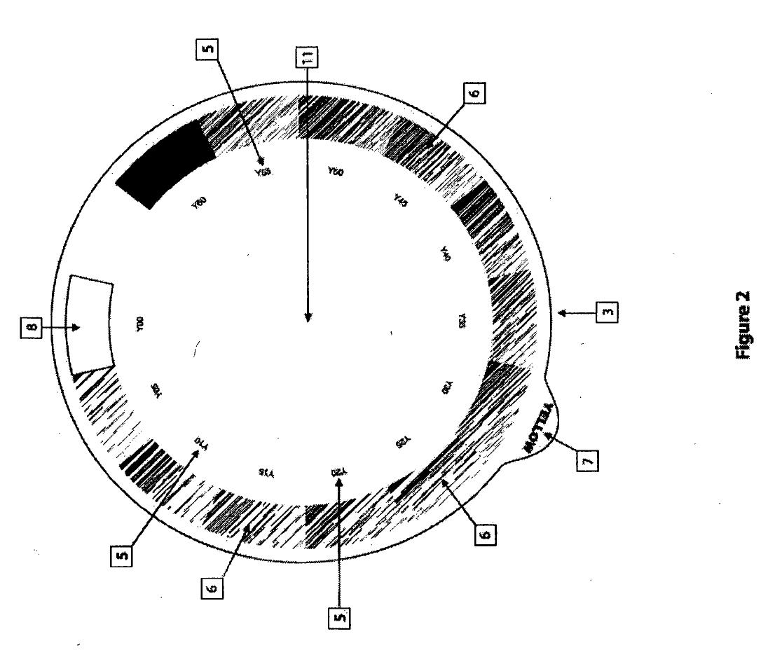

Referring to FIG. 2, a transparent disc (3) is seen including its color tab (7) as well as the seamless varying degrees of translucency and color (6) which are seen at various places around the circumference of the disc (3). The symbolic indicators (5) are once again marked and demarcate the varying degrees of transparency and color around the circumference of the disc (3). The color intensity on the discs (3) increases seamlessly around the circumference of the discs (3). The use of a plastic material in the manufacturing of the discs (3) aids in the creation of a seamless color transition around the circumference of the discs (3). The seamless color transition adds the user in demarcating the desired color. A clear opening (8) is in place and seen through the viewing area (4) when the discs (3) are in their resting or neutral position. There can be any number of discs (3) used in this invention which can give rise to numerous colors and color schemes by simply manipulating the color tabs (7) around the circumference of the holder (2). The color tabs (7) will move around the circumference of the holder (2) because they are all pinned or riveted (11) at their respective centers within said holder (2).

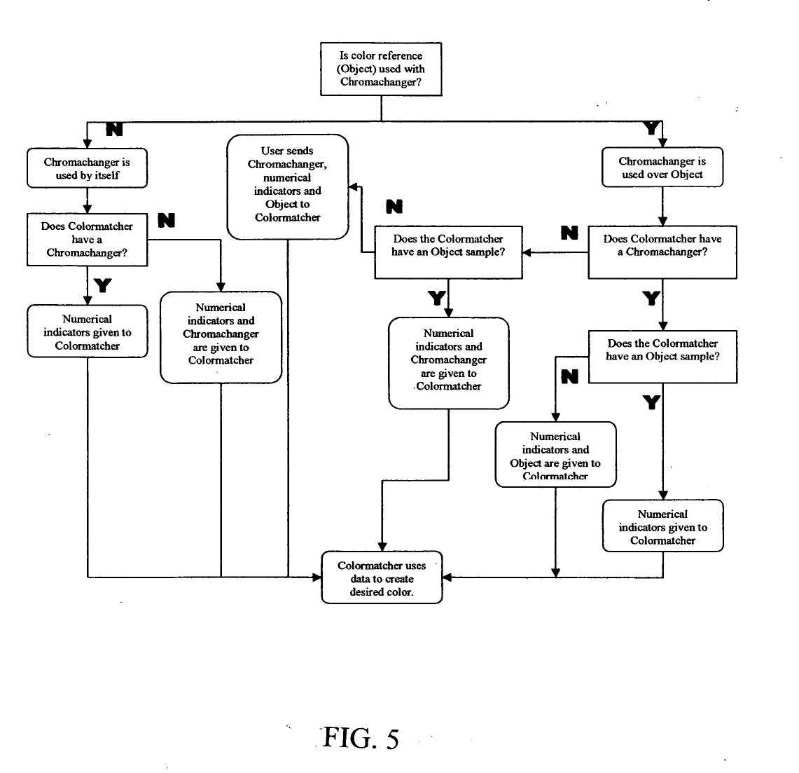

Referring to FIG. 5 is a flow chart that evidences how this color matching can or will take place. The letter Y in FIG. 5 represents yes and the letter N represents no. Referring to the terminology utilized in FIG. 5, chromochanger is the name of the device that is the subject of this description as termed in the flow chart. Colormatcher is essentially the technician or person who will utilize the data gathered from the invention to manifest such data in a tangible medium. The term Object refers to the medium in which color is to be duplicated or changed and numerical indicators are referred to throughout the rest of this embodiment as symbolic indicators. The flow chart in FIG. 5 illustrates how the invention can be utilized either when used by itself with the rear window of the opaque holder being rotated to reveal a neutral background as well as how the invention can be utilized when it is used over the actual object to be matched. If the invention is being utilized by itself, the rear portion of the opaque holder will be rotated by the user in such a manner that the rear window is rotated such that it does not align with the front viewing window located on the front portion of the opaque holder. A neutral background located on the inner surface of the back portion of the opaque holder, such as white, will form the backdrop for the colored discs. The discs will be manipulated by the user to form the desired color and the symbolic indicators will be recorded and the information will be used to create the desired color in the desired medium, be it paint, silicone or some other medium.

When the device is used over an object, such as a persons appendage or over a sample of a color, be it a high quality photograph of a persons appendage or a paint chip, the desired color is matched and the symbolic indicators are recorded and the information will be used to create the color in the desired medium.

As previously stated, this invention has many applications, and should not be limited to the fields or examples stated herein. For the purposes of this example only, this invention will be described in use with reference to matching the color of a prosthetic arm for a prosthetic patient. There are several methods by which this matching can take place using the present invention. Three of these methods are: (a) allowing the patient to take a high quality photograph of their skin tone around the area in which the prosthetic device will be attached; (b) sending a multitude of skin tone references to the patient and allowing them to match their skin tone to one of the existing skin tones and then referencing that tone to the prosthesis who in turn uses the invention to match this color; or (c) having the patient come into the office and using the invention to match the skin tone exactly. The later of the three is the most effective.

If a prosthetist and his or her patient use the invention in a manner as shown in the third illustration, they would first have the patient place the appendage in, need of the prosthetic on a stationary area, such as a table. The holder (2) will have its rear viewing area viewing area (4) in a closed position so as to allow for an objective matching of tones without interference from another color through the viewing area. The invention is then placed as close to the patient as possible. If the prosthesis was dealing with a patient in need of a prosthetic hand, the invention should be placed close to the wrist of the hand in which the prosthetic device will be attached so as to allow the color matching process to be as accurate as possible. This is to facilitate a close match in tone between the patient's skin and the prosthetic device.

The prosthetist will then manipulate the color tabs (7) from their respective resting positions (9) and monitor the viewing area (4) to compare the colors being seen in the viewing area (4) with the skin tone of the patient. The color tabs (7) can be moved clockwise or counter clockwise once out of their resting positions in such a manner that the varying color concentrations (6) on the discs (3) will fluctuate within the viewing window (4). The discs can either be made to go from more color concentration (6) to less color concentration or less to more. The best mode is thought to be less color concentration to more color concentration (6) on the discs (3).

As the color tabs (7) are manipulated the symbolic indicators (5) will evidence the varying degrees of color concentration (6) seen in the viewing window (4). The number of colors that may be represented by discs in the invention and within the holder (2) is really only limited by the purpose for which the invention is being used and the thickness of the invention itself. Obviously, the thicker the invention, the more discs (3) will be involved and consequently the more for color tabs (7) involved. However, if the invention becomes too thick with discs (3) the integrity of the color as scene in the viewing area or window (4) will diminish. The color tabs (7) only need to be of sufficient size to enable them to be labeled or characterized in some way.

Once the skin tone match has been accomplished may manipulating the invention, the prosthetist or some other person should record the symbolic indicators (5) as seen in the viewing window (4). As stated before, these symbolic indicators (5) represent percentages of color and essentially couple together to form a code by which the prosthetist can then manufacture a prosthetic device matching the skin tone of the patient. This color will typically be manifested in a silicone type coating over the prosthetic device, but this invention in no way limits its application to just silicone or any other applicable substance.

This invention should not be simply limited to the prosthetic field either. This invention has potential applications in virtually any field that requires objective color referencing. As stated before, the painting industry, be it commercial or residential, is very well suited for this invention. Instead of looking through mountains of “color swatches” at paint or hardware stores, consumers could simply pick up the “Green Chromochanger” which would contain color discs (3) of varying green color or colors used to produce varying shades of green and manipulate it until the desired shade of green is obtained.

The invention can be custom manufactured to tailor to various colors such as green, red or any other color imaginable. The holder (2) could house various shades of a particular color such as, but by no means limited to green, on individual discs (3). The color tabs (7) will evidence the various colors with varying concentrations (6) of those colors therein as described above. The holder (2) in this application will contain a closed back to the viewing area (4) so that the color reference is not interfered with by outside colors. The back portion of the opaque holder (2) can simply be rotated so as to reveal a neutral background on the inner surface of the back portion of the holder (2). The consumer will manipulate the color tabs (7) until a desired color is obtained and either record the symbolic indicators (5) or show the indicators to the store attendant who will mix the paint. The symbolic indicators (5) will give the mixer a formula or code by which he or she can mix colors in the appropriate portions to arrive at the desired paint color. The user could also rotate the back portion of the holder (2) open so that the front viewing window and rear viewing window align and place the device over an existing painting surface to ascertain a new similar shade of the existing color with the percentage to be mixed with the existing paint to arrive at this new shade being indicated by the symbolic indicators (5).

The specific techniques and embodiments disclosed herein are merely intended to be exemplary of this particular invention and should not be construed to be restrictive thereof because various modifications readily apparent to those skilled

I claim:

1. A display device for color identifying or matching, comprising:
one or more colored discs of varying transparency concentrically arranged, each having a tab attached to the periphery of the disc constituting a means to rotate the discs individually around a center pivot;
front and back circular opaque holder portions of similar dimensions to the discs attached to the front side and back side of the concentrically arranged discs,
the front and back opaque holder portions having a viewing window which recesses from the outer peripheral edge of the holder towards the center of the display device;
the discs and the opaque holders being attached at their center by a rivet facilitating rotation of the individual discs relative to each other and the opaque holders;
the individual discs having printed directly on said discs symbolic indicators which constitute the percentage of color in view; wherein:
(a) the symbolic indicators on the discs are viewable in the viewing window when said discs are rotated relative to the individual discs;
(b) the symbolic indicators are printed at a distance from the center of the display device on the individual disc so as to not interfere with the symbolic indicators from other discs.

2. The display device as in claim 1, further wherein:
(c) color intensities around the colored circular discs of varying translucency which initiate with little to no color intensity and increase seamlessly in color intensity around the circumference of the transparent discs.

3. The display device as in claim 1, further comprising:
the increasing color intensity around the circumference of the discs is demarcated by the symbolic indicators, each disc having its respective symbolic indicators arranged around the circumference of said disc according to color concentration based on percentage of color.

4. The display device as in claim 1, further comprising:
the colored discs of varying transparency being comprised from any and all colors and color variations.

5. The display device as in claim 4, wherein:
increasing color intensity around the circumference of the discs which initiate with little or no color intensity and increase seamlessly in color intensity around the circumference of the transparent discs.

6. The display device as in claim 1, further comprising:
a tab attached to the periphery of the transparent discs having printed on said tab the corresponding name of the color of the attached disc.

7. The display device as in claim 1, further comprising:
the back portion of the opaque holder being rotatable such that there is a corresponding viewing window as in the top portion of the opaque holder that may either align with the viewing window of the top portion of the opaque holder or be rotated to reveal a neutral colored background in the viewing area from inner surface of said back portion of the opaque holder.

8. The display device as in claim 7, wherein:
the neutral color of the back portion of the opaque holder is white.

9. The display device as in claim 1, further comprising:
the back portion of the opaque holder having no viewing area which recesses from the outer periphery of said holder, the inner surface of said back portion being a neutral color.

10. The display device as in claim 1, further comprising:
the transparent colored discs wherein said discs are comprised of plastic.

11. A method of color matching or identifying, comprising the steps of:
manipulating transparent colored discs with corresponding symbolic indicators printed on said discs by use of corresponding color tabs;
viewing changing color sequence of discs;
matching or identifying desired color through manipulation and viewing of said discs;
recording the information of symbolic indicators that demarcate desired color to be duplicated being viewed so that color may be later duplicated by persons responsible for creating or duplicating color in desired medium;
transferring recorded information from the symbolic indicators to persons responsible for creating or manifesting duplicate color in desired medium; and
creating or manifesting desired duplicate color in the desired medium.

12. The method of claim 11, wherein:
said transparent colored discs are manipulated by the user over a neutral background without reference to another object or color in color matching or identifying.

13. The method of claim 11, wherein:
said transparent colored discs are used over and with reference to an existing object in color matching or identifying.

14. The method of claim 11, wherein:
persons responsible for creating or manifesting duplicate colors in a desired medium are given a sample of an object or a copy of an object or the actual object in which color is either to be matched or identified and said persons utilize said discs and said corresponding symbolic indicators either adjacent to or over said object to create or manifest a like duplicate color.
